(19) United States
(12) Patent Application Publication
(10) Pub. No.: US 2021/0312654 A1
(43) Pub. Date: Oct. 7, 2021

(54) COMPUTER SYSTEM, OBJECT SITUATION DIAGNOSTIC METHOD AND PROGRAM

(71) Applicant: OPTIM CORPORATION, Saga (JP)

(72) Inventor: Shunji SUGAYA, Tokyo (JP)

(21) Appl. No.: 17/280,361

(22) PCT Filed: Sep. 27, 2018
(86) PCT No.: PCT/JP2018/035999

§ 371 Date: Mar. 26, 2021

(51) Int. Cl. G06T 7/73; G06K 9/46; G06K 9/62; G06T 7/55

(52) U.S. Cl. CPC G06T 7/73; G06T 7/55; G06K 9/6202; G06K 9/4604

(57) ABSTRACT

Provided is a computer system, and a method and a program that easily judge the situation of an object from an image. The computer system acquires an image; extracts a feature point in the image and analyzes at least two components selected from an object contained in the acquired image, the posture, the shape, and the orientation of the object, and the background in the image; acquires situation data indicating the situation of the object; associates and learns the combination of the components with the acquired situation data; and judges the situation of the object based on the learning result of the situation data when the result of analysis for a predetermined image is the same as or similar to the combination of the components.

### TECHNICAL FIELD

The present disclosure relates to a computer system, and a method and a program that judge the situation of an object.

### BACKGROUND

Recently, the situation of an object is judged based on its image. As such a composition that judges the situation of an object, the composition that detects a figure contained in an image and judges the situation of this figure based on the orientation and the movement information of this figure is disclosed (Refer to Patent Document 1).

### DOCUMENT IN THE EXISTING ART

### Patent Document

Patent Document 1: JP 2018-36848 A

### SUMMARY

However, the composition of Patent Document 1 merely judges the orientation of an object as the situation of the object but does not judge what the object is doing.

An objective of the present disclosure relates to a computer system, and a method and a program that easily judge the situation of an object from an image.

The present disclosure provides a computer system including:
an image acquisition unit that acquires an image;
an analysis unit that extracts a feature point in the image and analyzes at least two components selected from an object contained in the acquired image, the posture, the shape, and the orientation of the object, and the background in the image;
a situation acquisition unit that acquires situation data indicating the situation of the object;
a learning unit that associates and learns the combination of the components with the acquired situation data; and
a judgement unit that judges the situation of the object based on the learning result of the situation data when the result of analysis for a predetermined image is the same as or similar to the combination of the components.

According to the present disclosure, the computer system acquires an image; extracts a feature point in the image and analyzes at least two components selected from an object contained in the acquired image, the posture, the shape, and the orientation of the object, and the background in the image; acquires situation data indicating the situation of the object; associates and learns the combination of the components with the acquired situation data; and judges the situation of the object based on the learning result of the situation data when the result of analysis for a predetermined image is the same as or similar to the combination of the components.

The present disclosure is the category of a computer system, but the categories of a method, a program, etc. have similar functions and effects.

The present disclosure can provide a computer system, and a method and a program that easily judge the situation of an object from an image.

### BRIEF DESCRIPTION OF THE DRAWINGS

FIG. 1 is a schematic diagram of the system for judging the situation of an object 1.

FIG. 2 is an overall configuration diagram of the system for judging the situation of an object 1.

FIG. 3 is a flow chart illustrating the first object situation learning process performed by the computer 10.

FIG. 4 is a flow chart illustrating the second object situation learning process performed by the computer 10.

FIG. 5 is a flow chart illustrating the first object situation judging process performed by the computer 10.

FIG. 6 is a flow chart illustrating the second object situation judging process performed by the computer 10.

FIG. 7 schematically illustrates an image acquired by the computer 10.

FIG. 8 schematically illustrates an image acquired by the computer 10.

FIG. 9 schematically illustrates an image acquired by the computer 10.

FIG. 10 schematically illustrates an image acquired by the computer 10.

### DETAILED DESCRIPTION

Embodiments of the present disclosure will be described below with reference to the attached drawings. However, this is illustrative only, and the technological scope of the present disclosure is not limited thereto.

### Overview of System for Judging the Situation of an Object 1

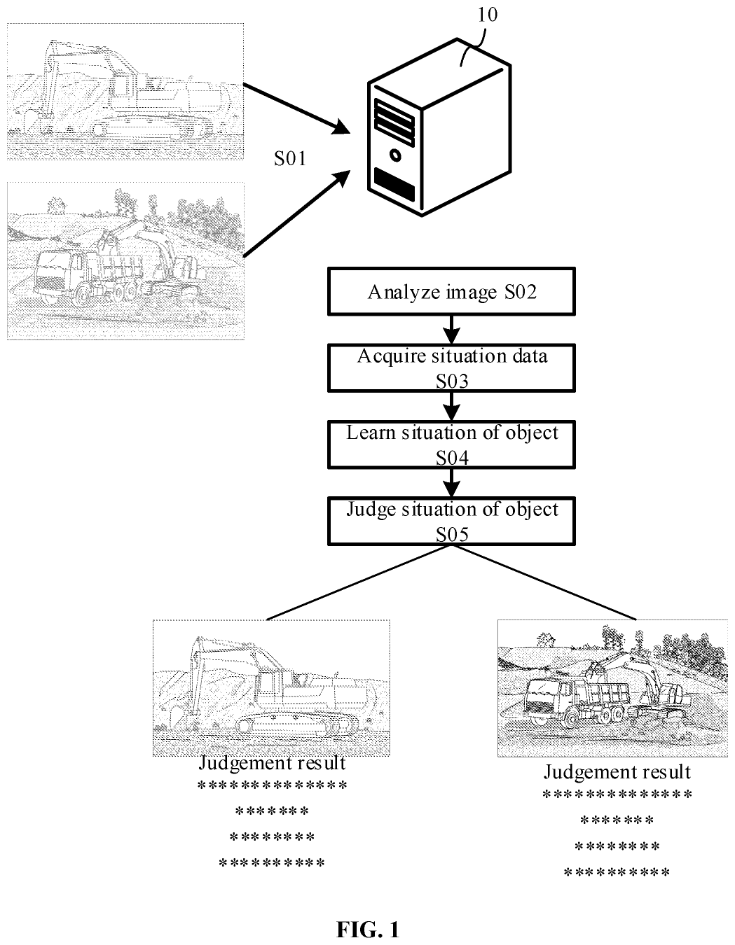

A preferable embodiment of the present disclosure is described below with reference to FIG. 1. FIG. 1 shows an overview of the system for judging the situation of an object 1 according to a preferable embodiment of the present disclosure. The system for judging the situation of an object 1 is a computer system including a computer 10 to judge the situation of an object contained in an image.

The system for judging the situation of an object 1 may include other terminals such as a user terminal (e.g., a mobile terminal such as a smart phone or a tablet terminal or an imaging device such as a camera) (not shown) owned by a user.

The computer 10 is data-communicatively connected with a user terminal through a public line network, etc., to transceive necessary data.

The computer 10 acquires an image taken by a user terminal or stored in other computers. The computer 10 extracts a feature point in the image and analyzes at least two components selected from an object contained in the acquired image, the posture, the shape, and the orientation of the object, and the background in the image. The computer 10 extracts and analyzes of a shape or an outline, or a statistically numerical value such as the average or the histogram of pixel values as the feature point.

If the image contains a plurality of objects, the computer 10 extracts a feature point in the image and analyzes each of the objects and then at least two components selected from each of the objects contained in the image, the posture, the shape, and the orientation of each of the objects, and the background in the image. The computer 10 also extracts a feature point in the image and analyzes the components of the combination of the plurality of objects and the relative positions between the objects.

The computer 10 acquires situation data indicating the situation of the object. The computer 10 acquires the situation (e.g., work instruction, operation, and place) of the object input from a user terminal as situation data. The computer 10 also acquires the situation of the object that is stored in other computers as situation data.

The computer 10 associates and learns the combination of the analyzed components with the acquired situation data. The computer 10 associates and learns at least two components selected from an object contained in the image, the posture, the shape, and the orientation of the object, and the background in the image with the acquired situation data. If the image contains a plurality of objects, the computer 10 associates and learns at least two components selected from each of the objects contained the image, the posture, the shape, and the orientation of each of the objects, and the background in the image with the acquired situation data. If the image contains a plurality of objects, the computer 10 also associates and learns the components of the combination of the plurality of objects and the relative positions between the objects with the acquired situation data.

The computer 10 judges the situation of the object based on the learning result of the situation data when the analysis result of the extraction of a feature point in a predetermined image and the analysis of at least two components selected from an object contained in the image, the posture, the shape, and the orientation of the object, and the background in the image is the same as or similar to the learning result of the combination of the components. If the image contains a plurality of objects, the computer 10 judges the situation of the object and what the plurality of objects are doing as a whole based on the learning result of the situation data when the analysis result of the extraction of a feature point in a predetermined image and the analysis of at least two components selected from each of the objects contained in the image, the posture, the shape, and the orientation of each of the objects, and the background in the image is the same as or similar to the learning result of the combination of the components. If the image contains a plurality of objects, the computer 10 judges the situation of the object and what the plurality of objects are doing as a whole based on the learning result of the situation data when the analysis result of the extraction of a feature point in a predetermined image and the components of the combination of the plurality of objects contained in the image and the relative positions between the objects is the same as or similar to the learning result of the combination of the components in the learning result.

The overview of the process that the system for judging the situation of an object 1 performs is described below.

The computer 10 acquires an image taken by a user terminal or stored in other computers (Step S01).

The computer 10 analyzes the image (Step S02). The computer 10 extracts a feature point in the image and analyzes at least two components selected from an object included in the acquired image, the posture, the shape, and the orientation of the object, and the background in the image (S02). The computer 10 extracts and analyzes a shape or an outline, or a statically numerical value such as the average or the histogram of pixel values as the feature point.

If the image contains a plurality of objects, the computer 10 extracts a feature point in the image and analyzes each of the objects and then at least two components selected from each of the objects contained in the image, the posture, the shape, and the orientation of each of the objects, and the background in the image. The computer 10 also extracts a feature point in the image and analyzes the components of the combination of the plurality of objects and the relative positions between the objects.

The computer 10 acquires situation data indicating the situation of the object (Step S03). The computer 10 acquires the situation of the object input from a user terminal (e.g., work instruction, operation, and place) as situation data. The computer 10 also acquires the situation of the object that is stored in other computers as situation data.

The computer 10 associates and learns the combination of the analyzed components with the acquired situation data (Step S04). The computer 10 learns the situation associated with the combination of the predetermined components to judge the situation of the object contained in the image having same or similar components.

The computer 10 associates and learns at least two components selected from an object contained in the image, the posture, the shape, and the orientation of the object, and the background in the image with the acquired situation data. If the image contains a plurality of objects, the computer 10 associates and learns at least two components selected from each of the objects contained the image, the posture, the shape, and the orientation of each of the objects, and the background in the image with the acquired situation data. If the image contains a plurality of objects, the computer 10 also associates and learns the components of the combination of the plurality of objects and the relative positions between the objects with the acquired situation data.

The computer 10 judges the situation of the object based on the learning result of the situation data when the result of analysis for a predetermined image is the same as or similar to the combination of the components (Step S05). The computer 10 extracts a feature point in the image and analyzes at least two components selected from an object contained in the predetermined image, the posture, the shape, and the orientation of the object, and the background in the image. The computer 10 judges the situation of the object contained in the predetermined image by comparing the combination of analyzed components with the combination of the components in the learning result. For example, the computer 10 uses the agreement rate of the combinations of the components for judging if the combinations are same or similar. The computer 10 judges if the agreement rate is a predetermined rate or more.

The computer 10 judges the situation of the object based on the learning result of the situation data when the analysis result of the extraction of a feature point in a predetermined image and at least two components selected from an object contained in the image, the posture, the shape, and the orientation of the object, and the background in the image is the same as or similar to the learning result of the combination of the components. If the image contains a plurality of objects, the computer 10 judges the situation of the object and what the plurality of objects are doing as a whole based on the learning result of the situation data when the analysis result of the extraction of a feature point in a predetermined image and at least two components selected from each of the objects contained in the image, the posture, the shape, and the orientation of each of the objects, and the background in the image is the same as or similar to the combination of the components in the learning result. If the image contains a plurality of objects, the computer 10 judges the situation of the object and what the plurality of objects are doing as a whole based on the learning result of the situation data when the analysis result of the extraction of a feature point in a predetermined image and the components of the combination of the plurality of objects contained in the image and the relative positions between the objects is the same as or similar to the learning result of the combination of the components.

### System Configuration of System for Judging the Situation of an Object 1

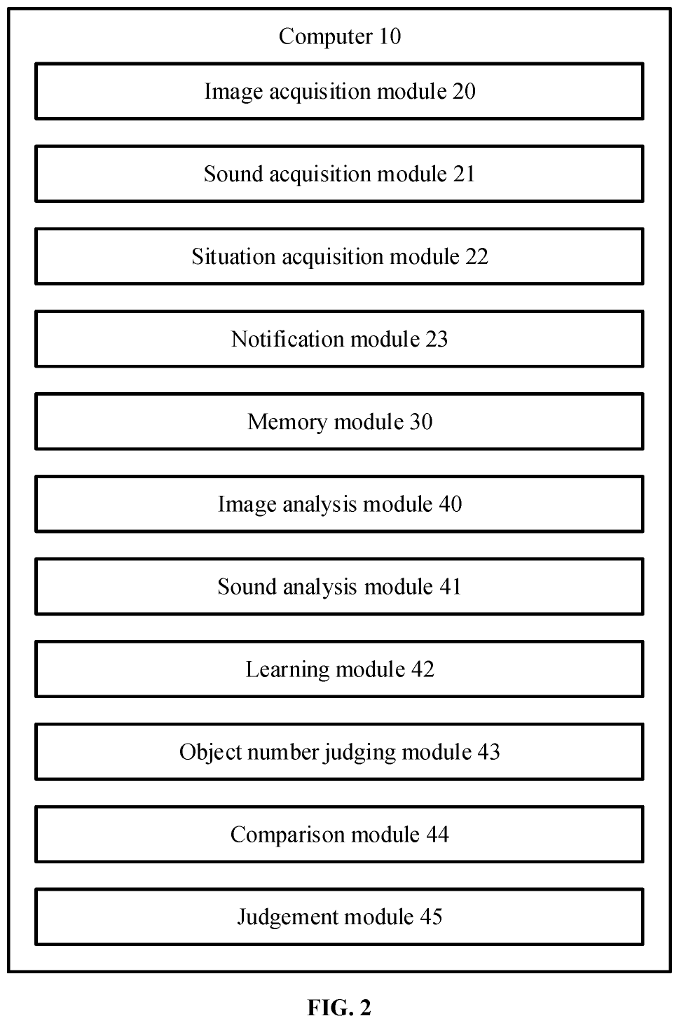

A system configuration of the system for judging the situation of an object 1 according to a preferable embodiment is described below with reference to FIG. 2. FIG. 2 is a block diagram illustrating the system for judging the situation of an object 1 according to a preferable embodiment of the present disclosure. In FIG. 2, the system for judging the situation of an object 1 is a computer system including a computer 10 to judge the situation of an object contained in an image. The computer 10 is data-communicatively connected with a user terminal and other computers through a public line network, etc., to transceive necessary data. The user terminal and other computers are not shown.

The computer 10 includes a central processing unit (hereinafter referred to as “CPU”), a random access memory (hereinafter referred to as “RAM”), and a read only memory (hereinafter referred to as “ROM”); and a communication unit such as a device that is capable to communicate with a user terminal and other computers, for example, a Wireless Fidelity or Wi-Fi® enabled device complying with IEEE 802.11. The computer 10 also includes a memory unit such as a hard disk, a semiconductor memory, a record medium, or a memory card to store data. The computer 10 also includes a processing unit provided with various devices that perform various processes.

In the computer 10, the control unit reads a predetermined program to achieve an image acquisition module 20, a sound acquisition module 21, a situation acquisition module 22, and a notification module 23 in cooperation with the communication unit. Furthermore, in the computer 10, the control unit reads a predetermined program to achieve a memory module 30 in cooperation with the memory unit. Furthermore, in the computer 10, the control unit reads a predetermined program to achieve an image analysis module 40, a sound analysis module 41, a learning module 42, an object number judging module 43, a comparison module 44, and a judgement module 45 in cooperation with the processing unit.

### First Object Situation Learning Process

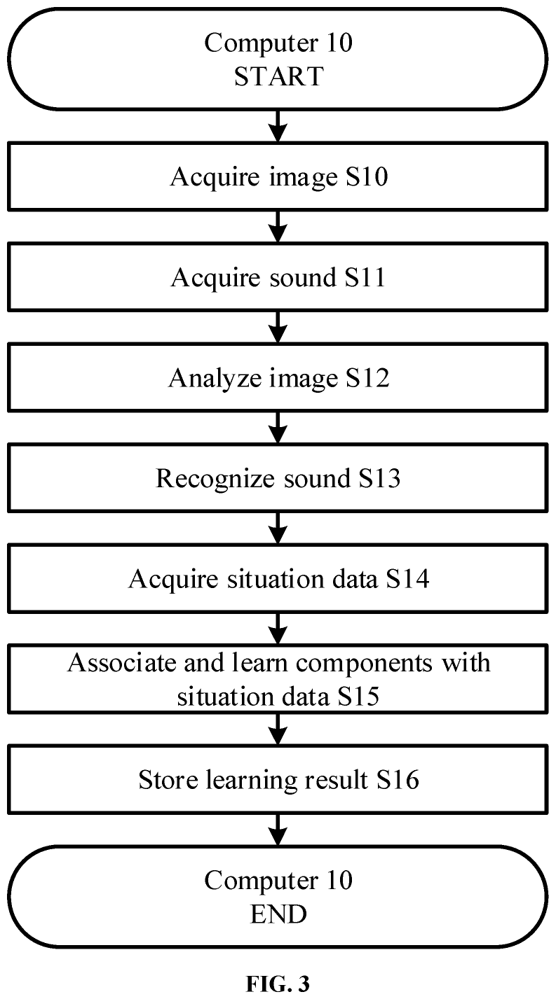

The first object situation learning process performed by the system for judging the situation of an object 1 is described below with reference to FIG. 3. FIG. 3 is a flow chart illustrating the first object situation learning process performed by the computer 10. The tasks executed by the modules are described below with this process.

The image acquisition module 20 acquires a still or moving image (Step S10). In Step S10, the image acquisition module 20 acquires the image, etc., taken by a user terminal or stored in other computers. For example, the user terminal transmits an image taken by the imaging device built in the user terminal to the computer 10 as image data. The image acquisition module 20 acquires the image by receiving the image data.

The sound acquisition module 21 acquires sound data (Step S11). In Step S11, the sound acquisition module 21 acquires the sound, etc., collected by a user terminal or stored in other computers. For example, when the user terminal takes an image, the user terminal collects a sound and transmits it to the computer 10 as sound data. The sound acquisition module 21 acquires the sound by receiving the sound data.

The step S11 can be skipped. In this case, the computer 10 only has to skip the process related to a sound in the process described later.

The image analysis module 40 analyzes the acquired image (Step S12). In Step 12, the image analysis module 40 extracts a feature point (e.g., a shape or an outline, or a statically numerical value such as the average or the histogram of pixel values) in the acquired image. The image analysis module 40 analyzes the components of the image based on the feature point. Examples of the component includes an object (e.g., the name and model of an object), the posture of the object (e.g., the state of each part composing the object, the movement of the part), the shape of the object (e.g., the outline or the shape of a feature part), the orientation of the object (e.g., the orientation of the object, the feature part, and each part), and the background (e.g., other than the object in the image).

As the combination of the components to be analyzed, at least two components are selected as described above. The combination more effectively to judge the situation better can be analyzed. For example, the image module 40 selects and analyzes the combination of the components more effectively to judge the situation better. Examples of such components include the combination at least including of an object and the orientation of the object, the combination at least including an object and the background, and the combination at least including the shape and the orientation of the object. The reason why these combinations are effective is because it is easy to judge what the object did (is doing), when, and how as judgement of the situation described later. The image analysis module 40 can also extract and analyze the combination of the components making the situation easy to judge in priority.

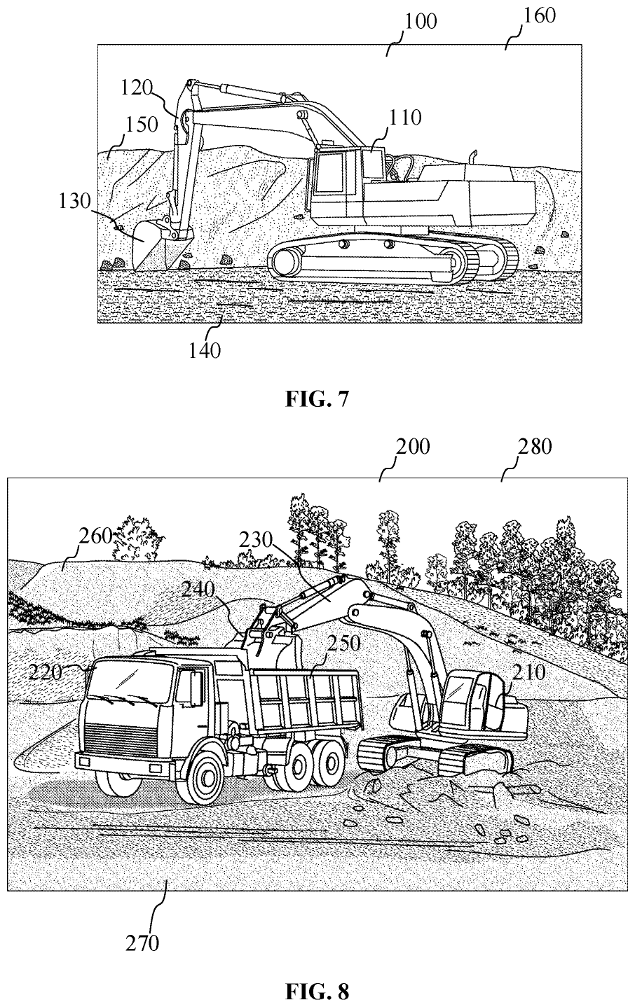

The image analysis that the image analysis module 40 performs is described below with reference to FIG. 7. FIG. 7 schematically illustrates an image acquired by the image acquisition module 20. The image analysis module 40 extracts a feature point by analyzing the image 100. The image analysis module 40 identifies an object 110 and the background 160 contained in the image 100 by extracting the feature point. The image analysis module 40 analyzes the components of the image 100 based on the extracted feature point. The image analysis module 40 analyzes an object 110 and the posture, the shape, and the orientation of the object 110 as the components of the image 100. The image analysis module 40 identifies the background 160 as the component of the image 100. The image analysis module 40 identifies the object 110 as a power shovel by the analysis. The image analysis module 40 identifies that the arm 120 is extending toward the ground 140 and that the teeth of the bucket 130 are in contact with the ground 140, as the posture of the object 110. The image analysis module 40 analyzes the outline of the power shovel and the shapes of the arm 120 and the bucket 130 as the shape of the object 110. The image analysis module 40 analyzes the orientation of the power shovel, the tip of the arm 120, the bucket 130, and the teeth of the bucket 130 as the orientation of the object 110. The image analysis module 40 identifies the background in the image 100 as the ground 140 and the dirt 150.

In FIG. 7, the image analysis module 40 analyzes all of the object 110, the posture, the shape, and the orientation of the object 110, the background in the image 100 as the components. However, the image analysis module 40 may analyze at least two components as described above. For example, the image analysis module 40 may analyze the object 110 and the posture of the object 110 as the components. The image analysis module 40 may analyze the posture, the shape, and the orientation of the object 110 as the components. The image analysis module 40 may analyze the object 110 and the background 160 in the image 100 as the components. The image analysis module 40 may analyze the combinations of other than these examples as the components.

The image analysis module 40 may analyze the components other than the above-mentioned examples. For example, the posture, the shape, and the orientation of the object 110 are not limited to the above-mentioned examples. Other portions, parts, etc. may be analyzed. Moreover, the background 160 in the image 100 is not limited to the above-mentioned examples. Other portions may be analyzed.

The sound recognition module 41 analyzes the acquired sound (Step S13). In Step S13, the sound recognition module 41 analyzes the acquired sound with a spectrum analyzer, etc., and recognizes a sound (e.g., the driving sound of the object and each part of the object, the exhaust sound of the object, the environmental sound) based on the sound waveform.

The situation acquisition module 22 acquires situation data indicating the situation of the object contained in the image (Step S14). In Step S14, the situation acquisition module 22 acquires the situation of the object input from a user terminal (e.g., work instruction, operation, and place) as situation data. The user terminal receives an input of the situation of the object from the user and transmits the received situation of the object as situation data. The situation acquisition module 22 also acquires also acquires the situation of the object that is stored in other computers as situation data. The other computers transmit the situation of the object that is stored in the computers as situation data. The situation acquisition module 22 acquires the situation data by receiving this data. For example, with reference to FIG. 7, the situation acquisition module 22 acquires the situation data indicating that the power shovel is digging up the ground in a construction site as the situation of the object 110.

As described above, the situation data indicates what the object did (is doing), when, and how.

The learning module 42 associates and learns the combination of the analyzed components with the acquired situation data (Step S15). In Step S15, the learning module 42 associates and learns the analyzed at least two components selected from an object, the posture, the shape, the orientation of this object, and the background that are contained in the image that the image analysis module 40 has analyzed with the component of the sound that the voice recognition module 41 has recognized and the situation data that the situation acquisition module 22 has acquired.

The learning module 42 may exclude the component of the recognized sound and then associate and learn the analyzed component with the situation data.

The process of Step S15 is described below with reference to FIG. 7. The learning module 42 associates and learns the analysis result of at least two components selected from the object 110, the posture, the shape, the orientation of this object 110, and the background 160 that are contained in the image with the situation data. Specifically, for example, the learning module 42 associates and learns the analysis result of at least two components selected from the object 110 as a power shovel; the posture of the object 110 that indicates that the arm 120 is extending toward the ground 140 and that the teeth of the bucket 130 are in contact with the ground 140; the shape of the object 110 as the outline of the power shovel and the shapes of the arm 120 and the bucket 130; the orientation of the object 110 as the orientation of the power shovel, the tip of the arm 120, the bucket 130, and the teeth of the bucket 130; and the background 160 as the ground 140 and the dirt 150 with the situation data.

The learning module 42 also associates and learns the recognition result of the two components with the sound and the situation data.

For example, if the learning module 42 associates and learns the analysis result of the components of the object 110 and the posture of the object 110 with the situation data, the learning module 42 associates and learns the object 110 as a power shovel; and the posture of the object 110 that indicates that the arm 120 is extending toward the ground 140 and that the teeth of the bucket 130 are in contact with the ground 140 with the situation data. If the learning module 42 associates and learns the analysis result of the components of the posture, the shape, and the orientation of the object 110 with the situation data, the learning module 42 associates and learns the posture of the object 110 that indicates that the arm 120 is extending toward the ground 140 and that the teeth of the bucket 130 are in contact with the ground 140; the shape of the object 110 as the outline of the power shovel and the shapes of the arm 120 and the bucket 130; and the orientation of the object 110 as the orientation of the power shovel, the tip of the arm 120, the bucket 130, and the teeth of the bucket 130 with the situation data. The same things go for other combinations.

In this example, the analysis result of all of the analyzed components are associated and learned with the situation data.

The memory module 30 stores the learning result (Step S16). The computer 10 uses the stored learning result for the process described later.

### Second Object Situation Learning Process

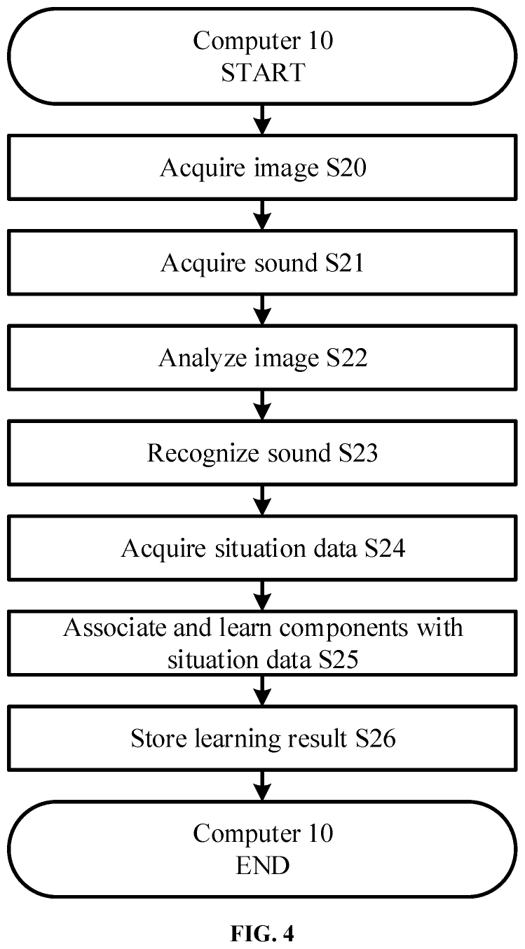

The second object situation learning process performed by the system for judging the situation of an object 1 is described below with reference to FIG. 4. FIG. 4 is a flow chart illustrating the second object situation learning process performed by the computer 10. The tasks executed by the modules are described below with this process.

The difference between the first object situation learning process and the second object situation learning process is the number of the objects contained in an image: one for the first object situation learning process while two or more for the second object situation learning process.

The detailed explanation of the tasks as same as those of the above-mentioned first object situation learning process is omitted.

The image acquisition module 20 acquires a still or moving image (Step S20). The step S20 is processed in the same way as the above-mentioned step S10.

The sound acquisition module 21 acquires sound data (Step S21). The step S21 is processed in the same way as the above-mentioned step S11.

The step S21 can be skipped. In this case, the computer 10 only has to skip the process related to a sound in the process described later.

The image analysis module 40 analyzes the acquired image (Step S22). In the step S22, the image analysis module 40 extracts a feature point in the image. The image analysis module 40 analyzes the components of the image based on the feature point. The examples of the components include each of the objects, the posture, the shape, and the orientation of each of the objects, and the background. The above-mentioned step S12 is processed for each of the objects. As the result, the image analysis module 40 analyzes at least two components selected from each of the objects, the posture, the shape, and the orientation of each of the objects, and the background.

As the combination of the components to be analyzed, at least two components are selected as described above. The combination more effectively to judge the situation better can be analyzed. For example, the image module 40 selects and analyzes the combination of the components more effectively to judge the situation better. Examples of such components include the combination at least including each of objects and the orientation of each of the objects, the combination at least including each of the objects and the background, and the combination at least including the shape and the orientation of each of the objects. The reason why these combinations are effective is because it is easy to judge what each of the objects did (is doing), when, and how as judgement of the situation described later. It is easy to judge what the plurality of objects did (are doing), when, and how as a whole as judgement of the situation described later. The image analysis module 40 can also extract and analyze the combination of the components making the situation easy to judge in priority.

The image analysis module 40 analyzes the components of the combination of a plurality of objects (contained in the image) and the relative positions (e.g., the positional relationship, the distance, and the arrangement between the objects) based on the feature point.

The image analysis that the image analysis module 40 performs is described below with reference to FIG. 8. FIG. 8 schematically illustrates an image acquired by the image acquisition module 20. The image analysis module 40 extracts a feature point by analyzing the image 200. The image analysis module 40 identifies the objects 210, 220 and the background 280 contained in the image 200 by extracting the feature point. The image analysis module 40 analyzes the components of the image 200 based on the extracted feature point. The image analysis module 40 analyzes the object 210, the posture, the shape, and the orientation of the object 210; the object 220, the posture, the shape, and the orientation of the object 220; and the background 280 as the components of the image 200. As the result, the image analysis module 40 analyzes each of the objects, the posture, the shape, and the orientation of each of the objects, and the background 280 as the components. The image analysis module 40 also analyzes the combination of the objects 210, 220 and the relative positions between the objects 210, 220 as the components.

The image analysis module 40 identifies the object 210 as a power shovel by the analysis. The image analysis module 40 identifies that the arm 230 is extending toward the object 220 and that the bucket 240 is in contact with the object 220, as the posture of the object 210. The image analysis module 40 analyzes the outline of the power shovel and the shapes of the arm 230 and the bucket 240 as the shape of the object 210. The image analysis module 40 identifies that the object 210, the arm 230, and the bucket 240 are facing to the object 220 as the orientation of the objects 210

The image analysis module 40 identifies the object 220 as a dump truck by the analysis. The image analysis module 40 identifies that the truck bed 250 is not inclined as the posture of the object 220. The image analysis module 40 analyzes the outline of the dump truck and the shape of the truck bed 250 as the shape of the object 220. The image analysis module 40 identifies that the object 220 is facing the opposite direction of the object 210 and that the truck bed 250 is facing to the object 210 as the orientation of the objects 220.

The image analysis module 40 also identifies the dirt 260 and the ground 270 as the background 280 contained in the image 200.

The image analysis module 40 identifies the combination of the objects 210, 220 as a power shovel and a dump truck. The image analysis module 40 also identifies that the objects 210, 220 are located adjacent to each other, especially that the arm 230 and the bucket 240 are located adjacent to the truck bed 250 as the relative positions between the objects 210, 220.

In FIG. 8, the image analysis module 40 analyzes all of the objects 210 and 210, the posture, the shape, and the orientation of the objects 210, 220, the background 280 in the image 200 as the components. However, the image analysis module 40 may analyze at least two components as described above. For example, the image analysis module 40 may analyze each of the objects 210, 220 and the posture of each of the objects 210, 220 as the components. The image analysis module 40 may analyze the posture, the shape, and the orientation of each of the objects 210, 220 as the components. The image analysis module 40 may analyze each of the objects 210, 220 and the background 280 in the image 200 as the components. The image analysis module 40 may analyze the combinations of other than these examples as the components.

The image analysis module 40 may analyze the components other than the above-mentioned examples. For example, the posture, the shape, and the orientation of each of the objects 210, 220 are not limited to the above-mentioned examples. Other portions, parts, etc. may be analyzed. Moreover, the background 280 in the image 200 is not limited to the above-mentioned examples. Other portions may be analyzed. Moreover, the combination of the objects 210, 220 is not limited to the above-mentioned examples. Other portions may be analyzed. Moreover, the relative positions between the objects 210, 220 are not limited to the above-mentioned examples. Other portions and parts may be analyzed.

The sound recognition module 41 analyzes the acquired sound (Step S23). The step S23 is processed in the same way as the above-mentioned step S13. In Step S23, the sound recognition module 41 recognizes the driving sound of each of the objects and each part of each of the objects, the exhaust sound of each of the object, the environmental sound, etc.

The situation acquisition module 22 acquires situation data indicating the situation of each of the objects contained in the image (Step S24). The step S24 is processed in the same way as the above-mentioned step S14. For example, with reference to FIG. 8, the situation acquisition module 22 acquires the situation data indicating that the power shovel is digging up the ground in a construction site and loading the dug up dirt as the situation of the object 210 and that the dump truck is being loaded with the dirt in the construction site as the situation of the object 220. The situation acquisition module 22 acquires the situation data indicating that the power shovel is loading the dug up dirt onto the dump truck in a construction site as the situation of the plurality of objects as a whole.

The learning module 42 associates and learns the combination of the components with the acquired situation data (Step S25). The step S25 is processed in the approximately same way as the above-mentioned step S15. In Step S25, the learning module 42 associates and learns the analyzed at least two components selected from each of objects, the posture, the shape, the orientation of each of the objects, and the background in the image that are contained in the image that the image analysis module 40 has analyzed with the component of the sound that the voice recognition module 41 has recognized and the situation data that the situation acquisition module 22 has acquired. The situation data with which the components are associated indicates the situations of each and all of the objects as a whole.

The learning module 42 associates and learns the components of the combination of objects and the relative positions between the objects contained in the image with the component of the sound that the voice recognition module 41 has recognized and the situation data that the situation acquisition module 22 acquired. The situation data with which the components are associated is the situation of all of the objects as whole.

The learning module 42 may exclude the component of the recognized sound and then associate and learn the analyzed component with the situation data.

The process of Step S25 is described below with reference to FIG. 8. The learning module 42 associates and learns the analysis result of at least two components selected from each of the objects 210, 220, the posture, the shape, the orientation of each of the objects 210, 220, and the background 280 that are contained in the image with the situation data. Specifically the learning module 42 associates and learns at least two components selected from the object 210 as a power shovel; the object 220 as a dump truck; the posture of the object 210 that indicates that the arm 230 is extending toward the object 220 and that the bucket 240 is in contact with the object 220; the posture of the object 220 that indicates that the truck bed 250 is not inclined; the shape of the object 210 as the outline of the power shovel and the shapes of the arm 230 and the bucket 240; the shape of the object 220 as the outline of the dump truck and the shape of the truck bed 250; the orientation of the object 210 that indicates that the object 210, the arm 230, and the bucket 240 are facing to the object 220; the orientation of the objects 220 that indicates that the object 220 is facing the opposite direction of the object 210 and that the truck bed 250 is facing to the object 210; and the background 280 as the dirt 260 and the ground 270 with the situation data.

The learning module 42 associates and learns the components of the combination of the objects 210, 220 and the relative positions between the objects 210, 220 contained in the image with the situation data. Specifically, the learning module 42 associates and learns the components of the combination of the objects 210, 220 as a power shovel and a dump truck; and the relative positions between the objects 210, 220 that indicate that the objects 210, 220 are located adjacent to each other, especially that the arm 230 and the bucket 240 are located adjacent to the truck bed 250 with the situation data.

The learning module 42 also associates and learns the recognition result of the two components with the sound and the situation data.

For example, if the learning module 42 associates and learns the analysis result of the components of the objects 210, 220 and the posture of the objects 210, 220 with the situation data, the learning module 42 associates and learns the object 210 as a power shovel; the object 220 as a dump truck; the posture of the object 210 that indicates that the arm 230 is extending toward the object 220 and that the bucket 240 is in contact with the object 220; and the posture of the object 220 that indicates that the truck bed 250 is not inclined with the situation data. If the learning module 42 associates and learns the analysis result of the components of the posture, the shape, and the orientation of objects 210, 220 with the situation data, the learning module 42 associates and learns at least two components selected from the posture of the object 210 that indicates that the arm 230 is extending toward the object 220 and that the bucket 240 is in contact with the object 220; the posture of the object 220 that indicates that the truck bed 250 is not inclined, the shape of the object 210 as the outline of the power shovel and the shapes of the arm 230 and the bucket 240; the shapes of the object 220 as the outline of the dump truck and the shape of the truck bed 250, the orientation of the object 210 that indicates that the object 210, the arm 230 and the bucket 240 are facing to the object 220; the orientation of the object 220 indicates that the object 220 is facing the opposite direction of the object 210 and that the truck bed 250 is facing to the object 210 with the situation data. The same things go for other combinations.

If the learning module 42 associates and learns the analysis result of the components of the combination of the objects 210, 220 and the relative positions between the objects 210, 220 with the situation data, the learning module 42 associates and learns the components of the combination of the objects 210, 220 as a power shovel and a dump truck; and the relative positions between the objects 210, 220 that indicate that the objects 210, 220 are located adjacent to each other, especially that the arm 230 and the bucket 240 are located adjacent to the truck bed 250 with the situation data.

In this example, the analysis result of all of the analyzed components are associated and learned with the situation data.

The memory module 30 stores the learning result (Step S26). The computer 10 uses the stored learning result for the process described later.

### First Object Situation Judging Process

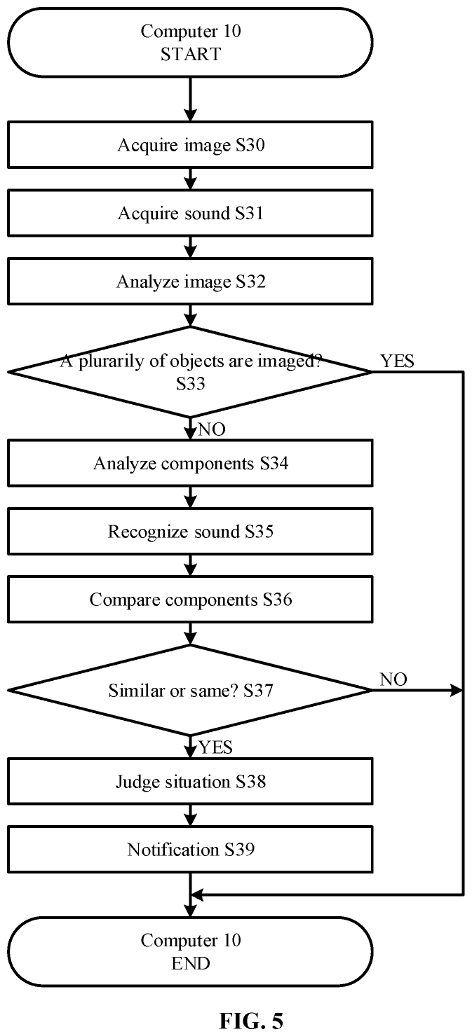

The first object situation judging process performed by the system for judging the situation of an object 1 is described below with reference to FIG. 5. FIG. 5 is a flow chart illustrating the first object situation judging process performed by the computer 10. The tasks executed by the modules are described below with this process.

The image acquisition module 20 acquires a still or moving image (Step S30). The step S30 is processed in the same way as the above-mentioned step S10.

The sound acquisition module 21 acquires sound data (Step S31). The step S31 is processed in the same way as the above-mentioned step S11.

The step S11 can be skipped. In this case, the computer 10 only has to skip the process related to a sound in the process described later.

The image analysis module 40 analyzes the acquired image (Step S32). In the step S32, the image analysis module 40 extracts a feature point in the image.

The object number judging module 43 judges if a plurality of objects are contained in the image based on the extracted feature point (Step S33). In Step S33, the object number judging module 43 judges if a plurality of objects are contained in the image by judging the number of objects contained in the image based on the extracted feature point.

If the object number judging module 43 judges that a plurality of objects are contained in the image (Step S33, YES), the computer 10 performs the second object situation judging process described later. This process is ended here to simplify the explanation.

On the other hand, if the object number judging module 43 judges that a plurality of objects are not contained in the image (Step S33, NO), the image analysis module 40 analyzes the components of the image based on the feature point (Step S34). The step S34 is processed in the same way as the above-mentioned step S12.

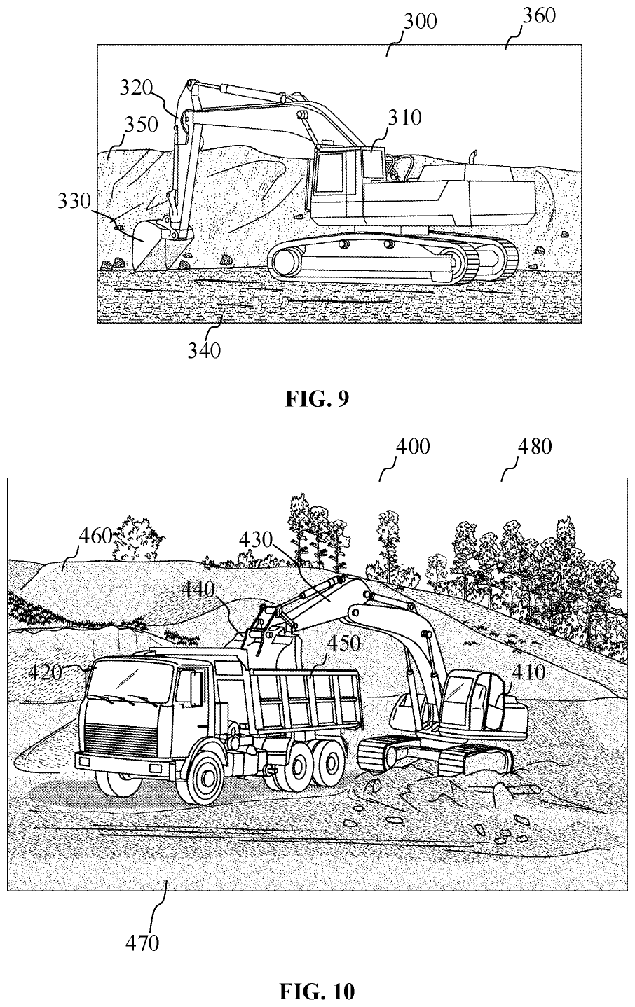

The image analysis that the image analysis module 40 performs is described below with reference to FIG. 9. FIG. 9 schematically illustrates an image acquired by the image acquisition module 20. The image analysis module 40 extracts a feature point by analyzing the image 300. The image analysis module 40 identifies an object 310 and the background 360 contained in the image 300 by extracting the feature point. The image analysis module 40 analyzes the components of the image 300 based on the extracted feature point. The image analysis module 40 analyzes an object 310 and the posture, the shape, and the orientation of the object 310 as the components of the image 300. The image analysis module 40 analyzes the background 360 as the component of the image 300. The image analysis module 40 identifies the object 310 as a power shovel by the analysis. The image analysis module 40 identifies that the arm 320 is extending toward the ground 340 and that the teeth of the bucket 330 is in contact with the ground 340, as the posture of the object 310. The image analysis module 40 analyzes the outline of the power shovel and the shapes of the arm 320 and the bucket 330 as the shape of the object 310. The image analysis module 40 analyzes the orientation of the power shovel, the tip of the arm 120, the bucket 130, and the teeth of the bucket 330 as the orientation of the object 310. The image analysis module 40 identifies the background in the image 300 as the ground 340 and the dirt 350.

In FIG. 9, the image analysis module 40 analyzes all of the object 310, the posture, the shape, and the orientation of the object 310, the background 360 in the image 300 as the components. However, the image analysis module 40 may analyze at least two components as described above. For example, the image analysis module 40 may analyze the object 310 and its posture as the components. The image analysis module 40 may analyze the posture, the shape, and the orientation of the object 310 as the components. The image analysis module 40 may analyze the object 310 and the background in the image 300 as the components. The image analysis module 40 may analyze the combinations of other than these examples as the components.

The image analysis module 40 may refer to the learning result stored in the memory module 30 and analyze the combination of the components that corresponds to the components stored in the learning result.

The image analysis module 40 may analyze the components other than the above-mentioned examples. For example, the posture, the shape, and the orientation of the object 310 are not limited to the above-mentioned examples. Other portions, parts, etc. may be analyzed. Moreover, the background 360 in the image 300 is not limited to the above-mentioned examples. Other portions may be analyzed.

The sound recognition module 41 analyzes the acquired sound (Step S35). The step S35 is processed in the same way as the above-mentioned step S13.

The comparison module 44 compares the components of the analyzed image and sound with the components in the learning result stored by the memory module 30 (Step S36). In Step S36, the comparison module 44 compares the components of the object, the posture, the shape, and the orientation of the object, the background in the image, and the sound in the analysis result with the components of the object, the posture, the shape, and the orientation of the object, the background in the image, and the sound in the learning result. At this time, the comparison module 44 compares the combination of the components of the object, the posture, the shape, and the orientation of the object, the background in the image, and the sound that corresponds to the combination in the learning result with the combination of the components in the learning result. Specifically, if the components in the learning result are the object and the posture of the object, the comparison module 44 compares these components with the components of the object and the posture of the object in the analysis result. The comparison module 44 compares the combinations of other components in the same way.

The comparison module 44 may exclude the component of the sound and compare the components of the analyzed image with the components in the learning result stored by the memory module 30.

The comparison module 44 judges if the combinations of the components are same or similar as the comparison result. (Step S37). In Step S37, the comparison module 44 judges that the combinations of the components are same or similar by comparing the analysis result of the components with the learning result of the components. In the judgment of the same or similar combinations that the comparison module 44 performs, for example, the agreement rate of the components is used to judge if this agreement rate is a predetermined rate or more. For example, if the agreement rate of the components in the analysis result with those in the learning result exceeds 75%, the comparison module 44 judged that they are similar. For example, if the agreement rate of the components in the analysis result with those in the learning result exceeds 90%, the comparison module 44 judged that they are same.

In FIG. 9, the comparison module 44 judges the agreement rate of the components the object 310 as a power shovel; the posture of the object 310 that indicates that the arm 320 is extending toward the ground 340 and that the teeth of the bucket 330 is in contact with the ground 340; the shape of the object 310 as the outline of the power shovel and the shapes of the arm 320 and the bucket 330; the orientation of the object 310 as the orientation of the power shovel, the tip of the arm 120, the bucket 130, and the teeth of the bucket 330; and the background 360 as the ground 340 and the dirt 350 in the image 300 with the components as the learning result.

If the comparison module 44 judges that the combinations of the components are not same or similar (Step S37, NO), the judgement module 45 judges the situation of the object and ends the process.

The computer 10 may notify a user terminal, etc., that the situation of the object cannot be judged. The computer 10 may also increase the learning accuracy by performing the process of the above-mentioned steps S14 to S16 for the acquired image to increase the accuracy of judging the situation of the object. At this time, the computer 10 may notify to prompt an input of the situation data in addition to notifying that the situation of the object cannot be judged in the process of these steps.

On the other hand, if the comparison module 44 judges that the combinations of the components are same or similar (Step S37, YES), the judgement module 45 judges the situation of the object based on the learning result (Step S38). In Step S38, the judgement module 45 judges the situation data in the learning result associated with the combination of the components that are same as or similar to the analyzed combination as the situation of the object in the image. The judgement module 45 judges that the power shovel digging up the ground in a construction site as the situation data in the learning result that is same or similar to the object 310 the posture, the shape, and the orientation of the object 310, and the background as the situation of the image.

If the judgement module 45 judges two or more situations of the object, judgement module 45 may judge each of the situations based on the agreement rate and the possibility rate of each of the situations.

The notification module 23 notifies the user of the judgement result (Step S39). In Step S39, the notification module 23 outputs the judgement result to the user terminal. The user terminal displays the judgement result on its display unit and outputs the judgement result by voices. The notification module 23 notifies the user of the judgement result in this way.

If two or more situations have been judged, the notification module 23 may display each of the situations and the possibility rates on its display unit and output the judgement result by voices.

### Second Object Situation Judging Process

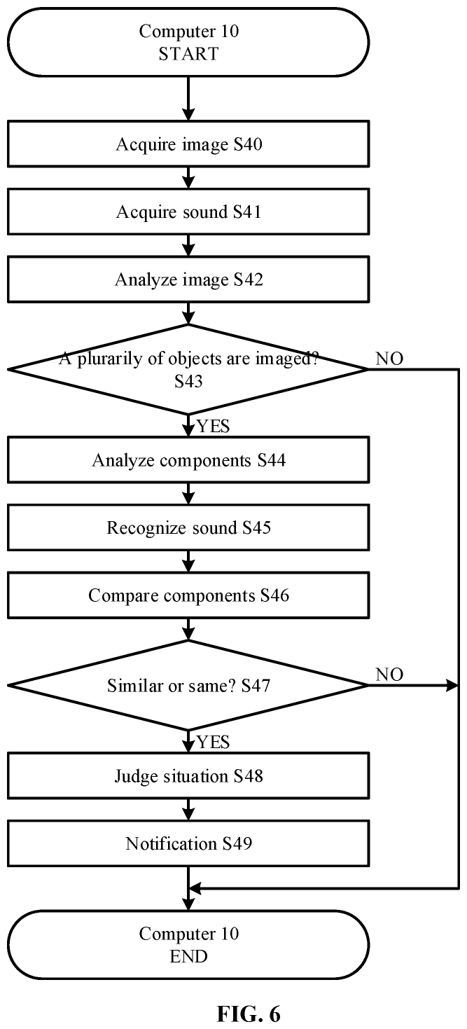

The second object situation judging process performed by the system for judging the situation of an object 1 is described below with reference to FIG. 6. FIG. 6 is a flow chart illustrating the second object situation judging process performed by the computer 10. The tasks executed by the modules are described below with this process.

The difference between the first object situation judging process and the second object situation judging process is the number of the objects contained in an image: one for the first object situation judging process while two or more for the second object situation judging process.

The image acquisition module 20 acquires a still or moving image (Step S40). The step S40 is processed in the same way as the above-mentioned step S10.

The sound acquisition module 21 acquires sound data (Step S41). The step S41 is processed in the same way as the above-mentioned step S11.

The step S41 can be skipped. In this case, the computer 10 only has to skip the process related to a sound in the process described later.

The image analysis module 40 analyzes the acquired image (Step S42). In the step S42, the image analysis module 40 extracts a feature point in the image.

The object number judging module 43 judges if a plurality of objects are contained in the image based on the extracted feature point (Step S43). The step S43 is processed in the same way as the above-mentioned step S33.

If the object number judging module 43 judges that a plurality of objects are not contained in the image (Step S43, NO), the computer 10 performs the above-mentioned first object situation judging process. This process is ended here to simplify the explanation.

On the other hand, if the object number judging module 43 judges that a plurality of objects are contained in the image (Step S43, YES), the image analysis module 40 analyzes the components of the image based on the feature point (Step S44). The step S44 is processed in the same way as the above-mentioned step S12.

The image analysis that the image analysis module 40 performs is described below with reference to FIG. 10. FIG. 10 schematically illustrates an image acquired by the image acquisition module 20. The image analysis module 40 extracts a feature point by analyzing the image 400. The image analysis module 40 identifies the objects 410, 420 and the background 480 contained in the image 400 by extracting the feature point. The image analysis module 40 analyzes the components of the image 400 based on the extracted feature point. The image analysis module 40 analyzes an object 410 and the posture, the shape, and the orientation of the object 410 as the components of the image 400. The image analysis module 40 also analyzes an object 420 and the posture, the shape, and the orientation of the object 420 as the components of the image 400. The image analysis module 40 identifies the background 480 as the component of the image 400.

The image analysis module 40 identifies the object 410 as a power shovel by the analysis. The image analysis module 40 identifies that the arm 430 is extending toward the object 420 and that the bucket 440 is in contact with the object 420, as the posture of the object 410. The image analysis module 40 analyzes the outline of the power shovel and the shapes of the arm 430 and the bucket 440 as the shape of the object 410. The image analysis module 40 identifies that the object 410, the arm 430, and the bucket 440 are facing to the object 420 as the orientation of the object 410.

The image analysis module 40 identifies the object 420 as a dump truck by the analysis. The image analysis module 40 identifies that the truck bed 450 is not inclined as the posture of the object 420. The image analysis module 40 analyzes the outline of the dump truck and the shape of the truck bed 450 as the shapes of the object 420. The image analysis module 40 identifies that the object 420 is facing the opposite direction of the object 410 and that the truck bed 450 is facing to the object 410 as the orientations of the objects 420.

The image analysis module 40 also analyzes the dirt 460 and the ground 470 as the background 480 contained in the image 400.

The image analysis module 40 identifies the combination of the objects 410, 420 as the combination of a power shovel and a dump truck. The image analysis module 40 also identifies that the objects 410, 420 are located adjacent to each other, especially that the arm 430 and the bucket 440 are located adjacent to the truck bed 450 as the relative positions between the objects 410, 420.

In FIG. 10, the image analysis module 40 analyzes all of the objects 410, 420, the posture, the shape, and the orientation of the objects 410, 420, the background in the image 400 as the components. However, the image analysis module 40 may analyze at least two components as described above. For example, the image analysis module 40 may analyze each of the objects 410, 420 and the posture of each of the objects 410, 420 as the components. The image analysis module 40 may analyze the posture, the shape, and the orientation of each of the objects 410, 420 as the components. The image analysis module 40 may analyze each of the objects 410, 420 and the background 480 in the image 400 as the components. The image analysis module 40 may analyze the combinations of other than these examples as the components.

The image analysis module 40 may refer to the learning result stored in the memory module 30 and analyze the combination of the components that corresponds to the components stored in the learning result.

The image analysis module 40 may analyze the components other than the above-mentioned examples. For example, the posture, the shape, and the orientation of the objects 410, 420 are not limited to the above-mentioned examples. Other portions, parts, etc. may be analyzed. Moreover, the background 480 in the image 400 is not limited to the above-mentioned examples. Other portions may be analyzed. Moreover, the combination of the objects and the relative positions between the objects are not limited to the above-mentioned examples. Other portions may be analyzed

The sound recognition module 41 analyzes the acquired sound (Step S45). The step S45 is processed in the same way as the above-mentioned step S13.

The comparison module 44 compares the components of the analyzed image and sound with the components in the learning result stored by the memory module 30 (Step S46). In Step S46, the comparison module 44 compares the components of the objects, the posture, the shape, and the orientation of each of the objects, the background in the image, and the sound in the analysis result with the components of the objects, the posture, the shape, and the orientation of each of the objects, the background in the image, and the sound as the learning result. At this time, the comparison module 44 compares the combination of the components of the objects, the posture, the shape, and the orientation of each of the objects, the background in the image, and the sound that corresponds to the combination in the learning result with the combination of the components in the learning result. Specifically, if the components in the learning result are the object and the posture of the object, the comparison module 44 compares these components with the components of the object and the posture of the object in the analysis result. The comparison module 44 compares the combinations of other components in the same way.

The comparison module 44 compares the components of the objects and the relative positions between the objects in the analysis result with the components of the objects and the relative positions between the objects in the learning result.

The comparison module 44 may exclude the component of the sound and compare the components of the analyzed image with the components in the learning result stored by the memory module 30.

The comparison module 44 judges if the combinations of the components are same or similar as the comparison result. (Step S47). The step S47 is processed in the same way as the above-mentioned step S37.

In FIG. 10, the comparison module 44 judges the agreement rate of the components the object 410 as a power shovel; the posture of the object 410 that indicates that the arm 430 is extending toward the object 420 and that the bucket 440 is in contact with the object 420; the shape of the object 410 as the outline of the power shovel and the shapes of the arm 430 and the bucket 440; the orientation of the object 410 that indicates that the object 410, the arm 430, and the bucket 440 are facing to the object 420; the object 420 as a dump truck; the posture of the object 420 that indicates that the truck bed 450 is not inclined; the orientation of the object 420 that indicates that the object 420 facing the opposite direction of the object 410 and that the truck bed 450 is facing to the object 410; and the background 480 as the dirt 460 and the ground 470 in the image 400 with the components as the learning result.

The comparison module 44 also judges the agreement rate of the components of the combination of the objects 410, 420 as a power shovel and a dump truck; and the relative positions between the objects 410, 420 that indicate that objects 410, 420 are located adjacent to each other, especially that the arm 430 and the bucket 440 are located adjacent to the truck bed 450 with the components as the learning result.

If the comparison module 44 judges that the combinations of the components are not same or similar (Step S47, NO), the judgement module 45 judges the situation of the object and ends the process.

The computer 10 may notify a user terminal, etc., that the situation of the object cannot be judged. The computer 10 may also increase the learning accuracy to the accuracy of judging the situation of the object by performing the process of the above-mentioned steps S24 to S26 for the acquired image. At this time, the computer 10 may notify to prompt an input of the situation data in addition to notifying that the situation of the object cannot be judged in the process of these steps.

On the other hand, if the comparison module 44 judges that the combinations of the components are same or similar (Step S47, YES), the judgement module 45 judges the situation of the object based on the learning result (Step S48). In Step S48, the judgement module 45 judges the situation data in the learning result associated with the combination of the components that are same as or similar to the combination in the analysis result as the situation of the object in the image. The judgement module 45 judges that the power shovel digging up the ground in a construction site as the situation of the object 410, that the dump truck is being loaded with the dirt in the construction site as the situation of the object 420, and that the power shovel is loading the dug up dirt onto the dump truck in a construction site as the situation of all the objects 410, 420 as a whole as the situation of the image based on the situation data in the learning result that is same or similar to the combination of the objects 410, 420, the posture, the shape, and the orientation of the objects 410, 420, and the background 480.

If the judgement module 45 judges two or more situations of the each of the objects, the judgement module 45 may judge each of the situations based on the agreement rate and the possibility rate of each of the situations.

The notification module 23 notifies the user of the judgement result (Step S49). The step S49 is processed in the same way as the above-mentioned step S39.

If two or more situations have been judged, the notification module 23 may display each of the situations and the possibility rates on its display unit and output the judgement result by voices.

To achieve the means and the functions that are described above, a computer (including a CPU, an information processor, and various terminals) reads and executes a predetermined program. For example, the program may be provided through Software as a Service (SaaS), specifically, from a computer through a network. or may be provided in the form recorded in a computer-readable medium such as a flexible disk, CD (e.g., CD-ROM), or DVD (e.g., DVD-ROM, DVD-RAM). In this case, a computer reads a program from the record medium, forwards and stores the program to and in an internal or an external storage, and executes it. The program may be previously recorded in, for example, a storage (record medium) such as a magnetic disk, an optical disk, or a magnetic optical disk and provided from the storage to a computer through a communication line.

The embodiments of the present disclosure are described above. However, the present disclosure is not limited to the above-mentioned embodiments. The effect described in the embodiments of the present disclosure is only the most preferable effect produced from the present disclosure. The effects of the present disclosure are not limited to those described in the embodiments of the present disclosure.

### DESCRIPTION OF REFERENCE NUMBERS

1 System for judging the situation of an object
10 Computer

1. A computer system comprising:
an image acquisition unit configured to acquire an image;
an analysis unit configured to extract a feature point in the image and analyze at least two components selected from an object contained in the acquired image, the posture, the shape, and the orientation of the object, and the background in the image;
a situation acquisition unit configured to acquire situation data comprising any one of a work, a behavior, and a work area that indicate what situation the object is in;
a learning unit configured to associate and learn the combination of the components with the acquired situation data; and
a judgement unit configured to judge the situation of the object based on the learning result of the situation data when the result of analysis for a predetermined image is the same as or similar to the combination of the components.

2. The computer system according to claim 1, wherein when a plurality of objects are contained in the image, the analysis unit is configured to analyze the image of each of the plurality of objects and extract a feature point in the image and then analyze the posture, the shape, and the orientation of the analyzed object, and the background in the image as the components, and the judgement unit is configured to judge what the plurality of objects are doing as a whole.

3. The computer system according to claim 1, wherein when a plurality of objects are contained in the image, the analysis unit is configured to extract a feature point in the image and analyze the combination of the plurality of objects and the relative positions between the objects as the components.

4. A method for judging the situation of an object that is performed by a computer system, comprising the steps of:
acquiring an image;
extracting a feature point in the image and analyzing at least two components selected from an object contained in the acquired image, the posture, the shape, and the orientation of the object, and the background in the image;
acquiring situation data comprising any one of a work, a behavior, and a work area that indicate what situation the object is in;
associating and learning the combination of the components with the acquired situation data; and
judging the situation of the object based on the learning result of the situation data when the result of analysis for a predetermined image is the same as or similar to the combination of the components.

5. A computer readable program for causing a computer system to execute the steps of:
acquiring an image;
extracting a feature point in the image and analyzing at least two components selected from an object contained in the acquired image, the posture, the shape, and the orientation of the object, and the background in the image;
acquiring situation data comprising any one of a work, a behavior, and a work area that indicate what situation the object is in;
associating and learning the combination of the components with the acquired situation data; and
judging the situation of the object based on the learning result of the situation data when the result of analysis for a predetermined image is the same as or similar to the combination of the components.
